(19) United States
(12) Patent Application Publication
(10) Pub. No.: US 2025/0056250 A1
(43) Pub. Date: Feb. 13, 2025

(54) MASTER NODE CENTRIC REFERENCE CONFIGURATION GENERATION

(71) Applicant: Nokia Technologies Oy, Espoo (FI)

(72) Inventors: Halit Murat GÜRSU, Munich (DE); Srinivasan SELVAGANAPATHY, Bangalore (IN); Shehzad Ali ASHRAF, Munich (DE); Krzysztof KORDYBACH, Wroclaw (PL); Umur KARABULUT, Munich (DE)

(21) Appl. No.: 18/770,013

(22) Filed: Jul. 11, 2024

(30) Foreign Application Priority Data
Aug. 10, 2023 (IN) 202341053789

(51) Int. Cl. H04W 24/02; H04W 12/06; H04W 36/36

(52) U.S. Cl. CPC H04W 24/02; H04W 12/06; H04W 36/362

(57) ABSTRACT

Embodiments of the present disclosure relate to apparatuses, methods, and computer readable storage media for master node centric reference configuration generation. In the methods, a master node receives, from at least one secondary node, respective cell configurations of one or more cells prepared as candidate primary secondary cells for a terminal device. Then, the master node generates a reference configuration for the one or more cells based on the respective cell configurations, and obtains respective delta configurations for the one or more cells. A delta configuration represents a difference between a cell configuration of a respective cell and the reference configuration. Moreover, the master node transmits the reference configuration and the respective delta configurations to at least one of the terminal device, or a serving secondary node of the terminal device. Thereby, the proposed solutions can advantageously minimize the signaling overhead.

### FIELDS

Various example embodiments of the present disclosure generally relate to the field of telecommunication and in particular, to methods, devices, apparatuses and computer readable storage medium for master node (MN) centric reference configuration generation.

### BACKGROUND

Dual Connectivity is a mode of operation where a terminal device (for example, user equipment, UE) can be configured to utilize radio resources provided by two network devices (for example, two base stations). A network device serves the terminal device as a Master Node (MN), and another network device serves the terminal device as a Secondary Node (SN). The MN and SN are connected via a non-ideal back-haul over a network interface and at least the MN is connected to a core network.

The MN and SN may provide one or more serving cells. In a carrier aggregation (CA) scenario, each of the MN and SN may provide a group of serving cells including a primary cell (PCell) and optionally one or more secondary cells (SCells). The group of serving cells associated with the MN is referred to as a Master Cell Group (MCG) and the group of serving cells associated with the SN is referred to as a Secondary Cell Group (SCG).

### SUMMARY

In a first aspect of the present disclosure, there is provided an apparatus. The apparatus comprises at least one processor; and at least one memory storing instructions that, when executed by the at least one processor, cause the apparatus to: receive, from at least one secondary node, respective cell configurations of one or more cells prepared as candidate primary secondary cells for a terminal device; generate a reference configuration for the one or more cells based on the respective cell configurations; obtain respective delta configurations for the one or more cells, wherein a delta configuration represents a difference between a cell configuration of a respective cell and the reference configuration; and transmit the reference configuration and the respective delta configurations to at least one of the terminal device, or a serving secondary node of the terminal device.

In a second aspect of the present disclosure, there is provided an apparatus. The apparatus comprises at least one processor; and at least one memory storing instructions that, when executed by the at least one processor, cause the apparatus to: determine a cell configuration of a cell prepared as a candidate primary secondary cell for a terminal device; and transmit the cell configuration to a master node serving the terminal device for generating a reference configuration for one or more cells comprising the cell.

In a third aspect of the present disclosure, there is provided an apparatus. The apparatus comprises at least one processor; and at least one memory storing instructions that, when executed by the at least one processor, cause the apparatus to: receive, from a master node or a serving secondary node, a reference configuration and respective delta configurations for one or more cells prepared as candidate primary secondary cells for the apparatus, wherein a delta configuration represents a difference between a cell configuration of a respective cell and the reference configuration; and in accordance with a determination that an execution condition is met for a first cell of the one or more cells, apply the delta configuration of the first cell and the reference configuration.

In a fourth aspect of the present disclosure, there is provided a method. The method comprises: receiving, from at least one secondary node, respective cell configurations of one or more cells prepared as candidate primary secondary cells for a terminal device; generating a reference configuration for the one or more cells based on the respective cell configurations; obtaining respective delta configurations for the one or more cells, wherein a delta configuration represents a difference between a cell configuration of a respective cell and the reference configuration; and transmitting the reference configuration and the respective delta configurations to at least one of the terminal device, or a serving secondary node of the terminal device.

In a fifth aspect of the present disclosure, there is provided a method. The method comprises: determining a cell configuration of a cell prepared as a candidate primary secondary cell for a terminal device; and transmitting the cell configuration to a master node serving the terminal device for generating a reference configuration for one or more cells comprising the cell.

In a sixth aspect of the present disclosure, there is provided a method. The method comprises: receiving, from a master node or a serving secondary node, a reference configuration and respective delta configurations for one or more cells prepared as candidate primary secondary cells for the apparatus, wherein a delta configuration represents a difference between a cell configuration of a respective cell and the reference configuration; and in accordance with a determination that an execution condition is met for a first cell of the one or more cells, applying the delta configuration of the first cell and the reference configuration.

In a seventh aspect of the present disclosure, there is provided a first apparatus. The first apparatus comprises means for receiving, from at least one secondary node, respective cell configurations of one or more cells prepared as candidate primary secondary cells for a terminal device; means for generating a reference configuration for the one or more cells based on the respective cell configurations; means for obtaining respective delta configurations for the one or more cells, wherein a delta configuration represents a difference between a cell configuration of a respective cell and the reference configuration; and means for transmitting the reference configuration and the respective delta configurations to at least one of the terminal device, or a serving secondary node of the terminal device.

In an eighth aspect of the present disclosure, there is provided a second apparatus. The second apparatus comprises means for determining a cell configuration of a cell prepared as a candidate primary secondary cell for a terminal device; and means for transmitting the cell configuration to a master node serving the terminal device for generating a reference configuration for one or more cells comprising the cell.

In a ninth aspect of the present disclosure, there is provided a third apparatus. The third apparatus comprises means for receiving, from a master node or a serving secondary node, a reference configuration and respective delta configurations for one or more cells prepared as candidate primary secondary cells for the apparatus, wherein a delta configuration represents a difference between a cell configuration of a respective cell and the reference configuration; and means for in accordance with a determination that an execution condition is met for a first cell of the one or more cells, applying the delta configuration of the first cell and the reference configuration.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for reference configuration generation according to some example embodiments of the present disclosure;

FIG. 3 illustrates a signaling chart for reference configuration generation in a first scenario according to some example embodiments of the present disclosure;

FIG. 4 illustrates a signaling chart for reference configuration generation in a second scenario according to some example embodiments of the present disclosure;

FIG. 5 illustrates a signaling chart for reference configuration generation in a third scenario according to some example embodiments of the present disclosure;

FIG. 6 illustrates a signaling chart for reference configuration generation according in a fourth scenario to some example embodiments of the present disclosure;

FIG. 7 illustrates a flowchart of a method implemented at a master node according to some example embodiments of the present disclosure;

FIG. 8 illustrates a flowchart of a method implemented at a secondary node according to some example embodiments of the present disclosure;

FIG. 9 illustrates a flowchart of a method implemented at a terminal device according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

### Example Environment

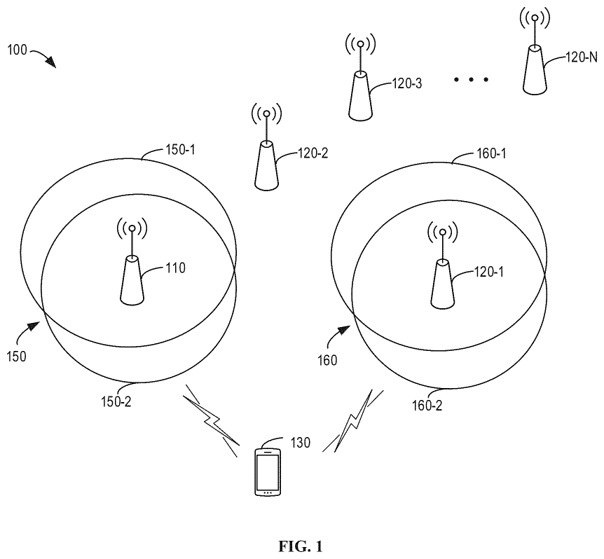

FIG. 1 shows an example communication environment 100 in which example embodiments of the present disclosure can be implemented. In the example of FIG. 1, a plurality of network nodes (for example, radio access network nodes) are deployed, where N is an integer larger than 1. Each network node may be implemented at or as a network device. The node 110 serves the terminal device 130 as the MN and thus is also referred to as the MN 110.

In some example embodiments, if the terminal device 130 is in a single connectivity, the nodes 120 may be candidate SNs for the terminal device 130. In some example embodiments, the terminal device 120 may be in dual connectivity, with the node 120-1 serving the terminal device 130 as the SN. In such example embodiments, other nodes 120 other than the node 120-1 may be candidate SNs for the terminal device 130. Therefore, in the following, the nodes 120-1, 120-2, 120-3 . . . 120-N may be collectively or individually referred to as SNs 120 or SN 120.

The serving areas of the nodes are called as cells. As shown in FIG. 1, a group of cells of the MN 110 includes a primary cell 150-1 and a secondary cell 150-2. The group of cells of the network device 110 is referred to as MCG 150 and the primary cell 150-1 is also referred to as PCell 150-1.

A group of cells of the SN 120-1 includes a primary cell 160-1 and a secondary cell 160-2. The group of cells of the network device 120-1 is referred to as SCG 160 and the primary cell 160-1 is also referred to as PSCell 160-1. The PCell 150-1 and PSCell 160-1 may be collectively referred to as SpCell.

For the purpose of clarity, the cells of the SNs 120-2, 120-3 . . . 120-N are not shown in FIG. 1. It is to be understood that the number of SCells in FIG. 1 is given for the purpose of illustration without suggesting any limitations to the present disclosure. Each node may provide any suitable number of SCells for serving the terminal device 130.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The concept of delta configuration is well-known in LTE and 5G (Non-Standalone (NSA), Standalone (SA)). The new configuration is delta over the current configuration. The concept of delta configuration is particularly used for handover, i.e., configuration of target cell is a delta over the configuration of source cell. In conditional handover (CHO), target PCell configuration is delta over source PCell configuration. In conditional PSCell change (CPC), the target PSCell configurations is delta over source PSCell configuration.

In selective activation (both SCG and MCG), the target PCell and PSCell configurations are delta over source PCell and PSCell configurations, respectively. In lower layer mobility (L1/L2 based), the target cell configurations are delta over the source cell.

In some cases, delta configuration is supported, i.e., there need to be a known reference. In some further cases, a UE stores the reference configuration as a separate configuration. The reference configuration is managed separately. In some still further cases, for inter-SN CPC, MN should provide the reference configuration to all candidate T-SNs (in order to generate the T-SN candidate configuration). As used herein, a target SN may also be denoted as T-SN, and a source SN may also be denoted as S-SN. The Radio Resource Control (RRC) reconfiguration may be formed based on two components, i.e., reference configuration, and delta configuration. The reference configuration will be a unique configuration that the UE will use it as basis to apply the delta configurations. The delta configuration will be “per CG” basis per prepared PSCell and contains the incremental changes/modifications that needs to be applied on top of the reference configuration. Once the UE uses reference configuration and apply the delta configuration on top of the reference configuration, the UE obtains the full configuration that is used for handover to the target PSCell. The full configuration of a target PSCell may be formulated as:

Full Configuration=Reference Configuration+Delta Configuration.

As there will be multiple preparations in SAPC, each preparation will be configured with delta configuration and those delta configurations needs to be aligned with the unique reference configuration.

In the Selective Activation of PSCell Change (SAPC), determining the reference configuration by the node that initiates the preparation leads very complex coordination between the nodes that are involved in the dual connectivity and SAPC. The problem is more pronounced if there are multiple nodes that initiates the SAPC in different mobility procedures, such as, intra-SN SAPC with Signaling Radio Bearer 3 (SRB3), MN initiated inter/intra SN SAPC, SN initiated inter SN SAPC.

In some cases, for an inter-SN CPC, MN should provide the reference configuration to all candidate T-SNs, in order to generate the T-SN candidate configuration. However, it is not clear how the reference configuration will be generated, and which reference configuration will be provided from MN to T-SNs.

A reference configuration determination solution which satisfies at least one of the following requirements is desirable: 1) minimizing the signaling overhead in the air interface (main focus of the delta and reference configuration); 2) simple to coordinate the reference configuration between the network nodes; 3) avoid any invalidity issue of the delta configurations during the SAPC.

Several solutions are proposed herein to at least address the above-mentioned problem. The proposed solutions assume MN as the anchor point for reference configuration generation and maintenance. In most of the scenarios, it simplifies the coordination of SAPC preparation and reference configuration determination. The benefit is more pronounced if multiple SAPC preparations are considered together, such as, intra-SN SAPC with SRB3, MN initiated inter/intra SN SAPC, SN initiated inter SN SAPC.

In some example embodiments, the MN generates the reference configuration based on configurations received from all other nodes (including MN itself). In case new SAPC preparations needed (after MN configures UE with a reference configuration), MN provides the new reference configuration to target nodes to receive delta configurations in line with the reference configuration. For various scenarios (covering the above-mentioned scenarios), the proposed solutions provide solutions on how the MN can be an anchor point to define the reference. Additionally, the proposed solutions also provide a solution for MN as centric node to coordinate between the nodes for reference configuration maintenance in selective activation. Key aspects of the proposed solutions involve MN generation of reference and delta configurations towards UE based on full-configuration from SNs.

Example embodiments of the present disclosure will be described in detail below with reference to the accompanying drawings.

### Example Signaling Chart

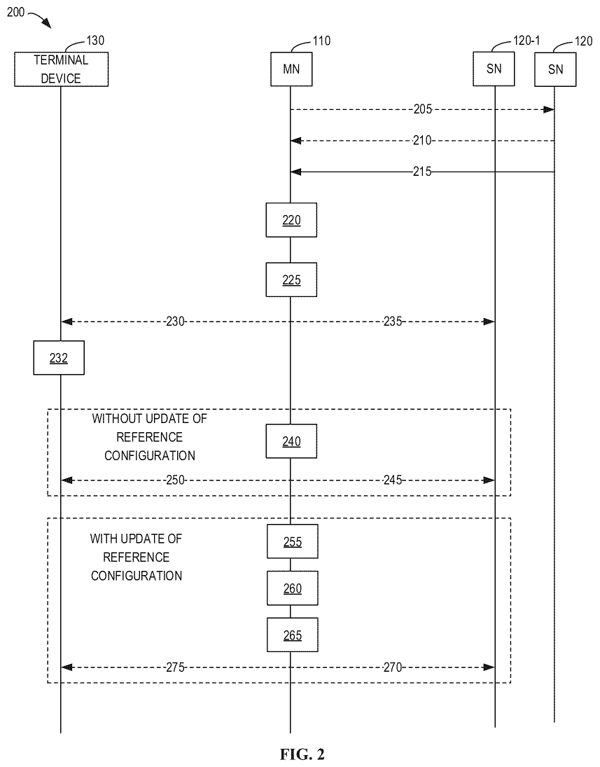

FIG. 2 illustrates a signaling chart 200 for reference configuration generation according to some example embodiments of the present disclosure. For the purposes of discussion, the signaling chart 200 will be discussed with reference to FIG. 1, for example, by using the MN 110, the at least one SN 120 and the terminal device 130. In some example embodiments, the chart 200 may involve the SN 120-1, which serves the terminal device 130 as a source SN (S-SN). It is to be noted that that in some example embodiments, the at least one SN 120 may comprise the SN 120-1, which is the S-SN. In some example embodiments, the at least one SN 120 may not include the S-SN, for example, in the scenario of inter-SN PSCell change.

The at least one SN 120 determines a cell configuration of a cell prepared as a candidate primary secondary cell for the terminal device 130. Then, the at least one SN 120 transmits (215) the cell configuration to the MN 110 serving the terminal device 130 for generating a reference configuration for one or more cells comprising the cell. The MN 110 receives, from at least one SN 120, the respective cell configurations of one or more cells prepared as candidate primary secondary cells for the terminal device 130.

In some example embodiments, before receiving the respective cell configurations, the MN 110 may transmit (205), to the at least one SN 120, a first indication that reference configuration generation is to be performed by a MN 110 of the terminal device 130. After receiving the first indication from the MN 110, the at least one SN 120 may transmit (210), to the network device, a second indication to authorize the MN 110 with the reference configuration generation.

At 220, the MN 110 generates a reference configuration for the one or more cells based on the respective cell configurations. In some example embodiments, the MN 110 may determine one or more information elements common to the respective cell configurations, and incorporate the one or more information elements into the reference configuration. For example, only the information element(s) common to all of the cell configurations will be added into the reference configuration.

Alternatively, for each information element of the plurality of information elements comprised in the reference configuration, the MN 110 may determine a value for the information element based on values for the information element in the respective cell configurations, and set the information element in the reference configuration with the determined value. By way of example rather than limitation, the MN 110 may select a most commonly used value among values for the information element in the respective cell configurations, and set this selected value as a value for the corresponding information element. For ease of discussion, it is assumed that there are ten cell configurations, and for a first information element, seven cell configurations of the ten cell configurations take a first value, while the rest of the ten cell configurations take a value different from the first value. Then, the MN 110 may set a value of for the first information element in the reference configuration to be equal to the first value. It should be understood that the above examples are described merely for purpose of description. The scope of the present disclosure is not limited in this respect.

At 225, the MN 110 obtains respective delta configurations for the one or more cells. A delta configuration represents a difference between a cell configuration of a respective cell and the reference configuration. In some example embodiments, the MN 110 may transmit the reference configuration to the at least one SN 120. In response to receiving the reference configuration from the MN 110, the at least one SN 120 may determine a delta configuration based on the cell configuration and the reference signal. Then, the at least one SN 120 may transmit the delta configuration to the MN 110. Correspondingly, the MN 110 receive the respective delta configurations from the at least one SN 120.

The MN 110 transmits (230) the reference configuration and the respective delta configurations to the terminal device 130. Additionally or alternatively, the MN 110 transmits (235) the reference configuration and the respective delta configurations to a serving secondary node (e.g., SN 120-1) of the terminal device 130.

In some example embodiments, after receiving the reference configuration and respective delta configurations from the MN 110, the serving secondary node (e.g., SN 120-1) may transmit the reference configuration and the respective delta configurations to the terminal device 130. By way of example, if the reference configuration and the respective delta configurations are transmitted only to the serving secondary node, and are not transmitted to the terminal device 130, the serving secondary node may transmit the reference configuration and the respective delta configurations to the terminal device 130.

In some example embodiments, the one or more cells may be prepared for conditional secondary node addition or conditional secondary node change initiated by a mater node serving the terminal device 130. The at least one SN 120 may act as a candidate secondary node of the terminal device 130. Moreover, the reference configuration and the respective delta configurations may be transmitted to the terminal device 130.

In some alternative example embodiments, the one or more cells may be prepared for an intra-node primary secondary cell change initiated by the serving secondary node. Alternatively, the one or more cells may be prepared for conditional secondary node change initiated by the serving secondary node. In such a case, the MN 110 may receive, from the serving secondary node, a request to prepare the candidate primary secondary cells for the terminal device 130. A secondary cell group configuration of the serving secondary node may be excluded from the request.

After receiving the reference configuration and respective delta configurations from the MN 110 or the serving secondary node, if it is determined that an execution condition is met for a first cell of the one or more cells, the terminal device 130 applies (232) the delta configuration of the first cell and the reference configuration. In some example embodiments, the terminal device 130 may maintain the reference configuration and at least a subset of the respective delta configurations. Additionally or alternatively, if it is determined that that an execution condition is met for a second cell of the one or more cells, the terminal device 130 may apply the delta configuration of the second cell and the reference configuration.

In a first scenario, the reference configuration may be not updated when further SAPC preparation is needed. The MN 110 may obtain (240) respective further delta configurations for one or more further cells prepared as further candidate secondary cells for the terminal device 130. A further delta configuration represents a difference between a further cell configuration of a respective further cell and the reference configuration.

In some example embodiments, the MN 110 may transmit the reference configuration to a first secondary node (e.g., one of the SN 120), which provides a first further cell of the one or more further cells. After receiving the reference configuration from the MN 110, the first secondary node may determine a further cell configuration for a first further cell prepared as a further candidate secondary cell for the terminal device 130. Moreover, the first secondary node may also determine a further delta configuration for the first further cell based on the further cell configuration and the reference configuration. Then, the first secondary node may transmit the further delta configuration of the first further cell to the MN 110. Correspondingly, the MN 110 may receive the further delta configuration of the first further cell from the first secondary node.

Alternatively, the MN 110 may transmit, to a second secondary node (e.g., one of the SN 120) a request to prepare the further candidate secondary cells for the terminal device 130. The second secondary node provides a second further cell of the one or more further cells. In response to receiving the request from the MN 110, the second secondary node may transmit, to the MN 110, a further cell configuration of a second further cell prepared as the further candidate secondary cell. Then, the MN 110 may receive, from the second secondary node, the further cell configuration of the second further cells. Moreover, the MN 110 may determine a further delta configuration of the second further cell based on the further cell configuration and the reference configuration.

It should be understood that the respective further delta configurations for one or more further cells may also be obtained by the MN 110 in any other suitable manner. The scope of the present disclosure is not limited in this respect.

After the respective further delta configurations is obtained, the MN 110 may transmit (250) the respective further delta configurations to the terminal device 130. Additionally or alternatively, the MN 110 may transmit (245) the respective further delta configurations to the serving secondary node (e.g., SN 120-1). The terminal device 130 may receive, from the MN 110 or the serving secondary node, respective further delta configurations for one or more further cells prepared as further candidate secondary cells for the apparatus.

In a second scenario, the reference configuration may be updated when further SAPC preparation is needed. The MN 110 may obtain (255) respective further cell configurations of one or more further cells prepared as further candidate primary secondary cells for the terminal device 130. Then, the MN 110 may generate (260) a further reference configuration for the one or more further cells based on the respective further cell configurations, and obtain (265) respective further delta configurations for the one or more further cells. A further delta configuration represents a difference between a further cell configuration of a respective further cell and the further reference configuration; and

In some example embodiments, the MN 110 may transmit (275) the further reference configuration and the respective further delta configurations to the terminal device 130. Additionally or alternatively, the MN 110 may transmit (270) the further reference configuration and the respective further delta configurations to the serving secondary node (e.g., SN 120-1). The terminal device 130 may receive, from the MN 110 or the serving secondary node, the further reference configuration and respective further delta configurations for one or more further cells prepared as further candidate primary secondary cells for the apparatus.

In view of the above, the proposed solutions are simple to coordinate the reference configuration between the network nodes. Moreover, the proposed solutions can advantageously minimize the signaling overhead in the air interface, and avoid invalidity issue of the delta configurations during the SAPC.

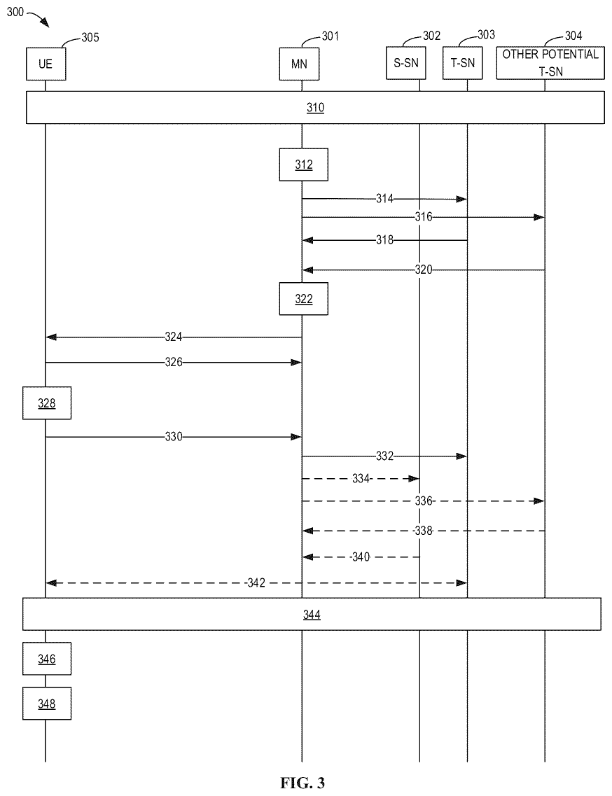

The solutions presented in FIG. 2 will be described in more details below with reference to FIGS. 3-7 based on four different scenarios hereinafter.

### First Scenario

The first scenario relates to a conditional secondary node addition procedure, or an MN initiated conditional SN change. FIG. 3 illustrates a signaling chart 300 for reference configuration generation in the first scenario according to some example embodiments of the present disclosure. With reference to FIG. 3, the solutions for two dual connectivity mobility scenarios are explained, i.e., conditional secondary node addition (CPA) or conditional SN change where both of them are initiated by MN.

In FIG. 3, the UE 305 may be an example implementation of the terminal device 130 in FIG. 1, the MN 301 may be an example implementation of the MN 110 in FIG. 1, and the S-SN 302, T-SN 303 and/or other potential T-SN 304 may be an example implementation of the SN 120 in FIG. 1.

At 310, in case of CPA, the UE 305 is in single connectivity. There is only MN 301 as serving node. Otherwise, in case of conditional SN change procedure, the UE 305 is in dual connectivity, i.e., both MN 301 and S-SN 302 as serving node.

At 312, the MN 301 determines to prepare a new PSCell as serving PSCell with selective activation of conditional reconfiguration, either CPA or CPC, depending on UE 305's initial connectivity.

At 314 and 316, the MN 301 sends the SN addition request to target SNs (i.e., T-SN 303 and other potential T-SN 304) to prepare candidate PSCells with conditional reconfiguration. MN 301 indicates to the target SNs to generate the full configurations upon PSCells are prepared as the reference will be provided later on, in case the target SN indicates that it doesn't support the reference configuration then the delta configuration may also be prepared as an alternative. MN 301 indicates that the MN 301 will generate the reference configurations out of the provided full configurations for selective activation. Alternatively, the target MN 301 avoids sending the source SCG configuration and sends set of UE 305 capabilities and the UE 305 measurement configuration along the measurement results. As part of measurement configuration MN 301 may send only the measurement object and reporting configuration related to the measurement results that are forwarded in the SN addition request.

At 318 and 320, T-SN 303 and other potential T-SN 304 prepare the requested candidate PSCells and provides the conditional configurations as full RRC reconfiguration for those prepared PSCells. Additionally, the T-SN 303 and other potential T-SN 304 may also indicate that they delegate the MN 301 to generate reference configuration out of the full configurations provided by the T-SNs. This might indicate the capability to fulfil reference configuration at the target SN side.

At 322, the MN 301 generates one reference configuration for all prepared PSCells that will be used as reference configuration by the UE 305 during SAPC. The MN 301 will also generate the delta configurations such that using each delta configuration along with the reference configuration results in the original full configuration that the target SNs provided for each prepared PSCell. Alternatively, the MN 301 may indicate the reference back to the target SN and the delta configuration may be provided by the target SN. It should be noted that the reference configuration is generated at the MN 301. Compared with the existing solutions where the delta configurations generated by the MN 301 was referring to source SN's or initial serving SN's RRC reconfiguration, in the proposed solutions, the delta configurations are generated for the reference configuration generated by MN 301.

At 324, the MN 301 provides the conditional reconfigurations of prepared PSCells in delta configuration form. The MN 301 also provides one reference configuration for all prepared target PSCells where the UE 305 will use the delta configurations along with the provided reference configuration.

At 326, the UE 305 confirms the reception of the provided configurations, e.g., by sending a RRCReconfigurationComplete message. The UE 305 stores the reference configuration on a dedicated variable.

At 328, once one of the execution conditions is met for a prepared PSCell, the UE 305 will use the delta configuration of that PSCell along with the provided reference configuration as configured in step 324. Hence the UE 305 will obtain the desired full configuration for that PSCell where the target SN has provided to the MN 301 during the preparation phase in steps 318 and 320.

At steps 330 to 344, the UE 305 access to that candidate PSCell that is determined in step 328. More specifically, at 330, the UE 305 transmits, to the MN 301, RRCReconfigurationComplete message containing SN RRCReconfigurationComplete for delta configuration of PSCell-1. At 332, the MN 301 transmits, to the T-SN 303, SN Reconfiguration Complete related to delta configuration of PSCell-1. At 334, the MN 301 transmits, to the S-SN 302, SN Release Request. At 336, the MN 301 transmits, to other potential T-SN 304, SN Release Request. At 338 and 340, the other potential T-SN 304 and the S-SN 302 transmits, to the MN 301, SN Release Request Acknowledge. At 342, the UE 305 and the T-SN 303 performs a random access procedure. At 344, an SAPC adaptation step is performed.

As it is one of the fundamental aspects of the selective activation, at 346, the UE 305 maintains the configurations of full or subset of the prepared PSCells for SAPC. The UE 305 also maintains the reference configuration that is provided by the MN 301 that is needed when the UE 305 applies the maintained delta configurations. Herein, the reference configuration is neither S-SN 302 nor initial SN configuration. It is a configuration that is only meant to be used along with the delta configurations and generated by MN 301.

At 348, as same as the step 328 (but for different PSCell), once the PSCell condition towards one of the prepared PSCells is met, the UE 305 will use the delta configuration of that PSCell along with the provided reference configuration as configured in step 324.

The above-described solution covers the case where the reference configuration can be updated by the MN. Similarly, in case the delta configuration is update the reference configuration is not changed. Aligning the delta configuration once the reference configuration is updated has to be taken care by the MN.

### Second Scenario

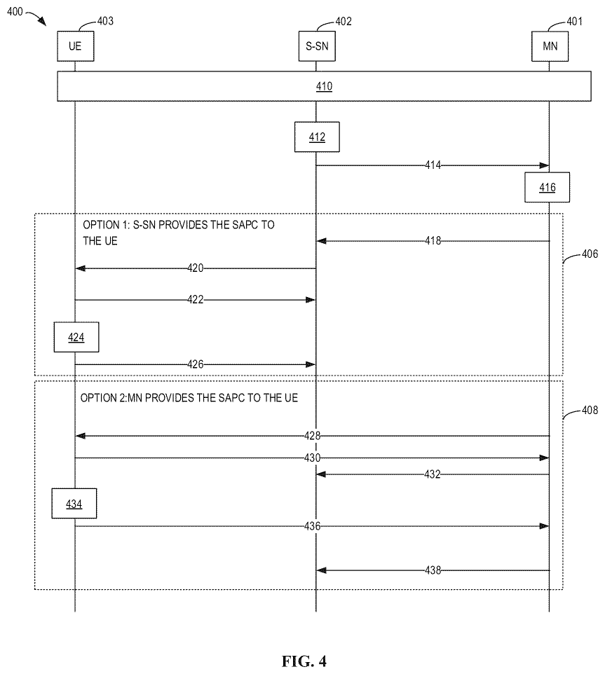

The second scenario relates to SN modification which is SN-initiated without MN involvement and SRB3 is used to configure CPC. FIG. 4 illustrates a signaling chart 400 for reference configuration generation in the second scenario according to some example embodiments of the present disclosure. Herein, a reference configuration generation solution for SAPC is proposed for the scenarios where the source SN initiates the preparation of the PSCells.

In FIG. 4, the UE 403 may be an example implementation of the terminal device 130 in FIG. 1, the MN 401 may be an example implementation of the MN 110 in FIG. 1, and the S-SN 402 may be an example implementation of the SN 120 in FIG. 1.

At 410, the UE 403 is in dual-connectivity as the PSCell preparation is initiated by the S-SN 402. At this stage, no CPA and CPC have been configured yet. At 412, S-SN 402 determines intra-SN SAPC and preparation of the PScells for SAPC. At 414, the S-SN 402 sends, to the MN 401, the full conditional reconfiguration for PSCells SAPC, so that the MN 401 can generate the delta configurations for each candidate PSCells and a common reference configuration for those delta configurations. Alternatively, the S-SNs may also indicate that they delegate the MN 401 to generate reference configuration out of the full configurations provided by the S-SNs.

At 416, the MN 401 generates reference configuration and delta configurations as described with reference to step 322 in FIG. 3. Herein, the MN 401 also makes sure that the conditional reconfiguration IDs that the S-SN 402 allocated for each full configuration are maintained (configured to each delta configuration after a full configuration is turned into delta configuration).

For a first option where S-SN 402 provides the SAPC to the UE 403, the actions shown in the rectangular box 406 will be performed. At 418, the MN 401 sends the reference configuration and delta configurations (such as one reference configuration for all full configs, and delta configurations for each target PSCell or SN Modification Confirm) to the S-SN 402. Then, the S-SN 402 configures the UE 403 with the SAPC by using the reference and delta configurations received from MN 401. More specifically, at 420, the S-SN 402 sends RRC Reconfiguration (containing SAPC) to the UE 403. For example, one reference configuration for all full configurations and delta configuration per PScell. At 422, the UE 403 confirms the reception of the provided configurations, e.g., by sending a RRCReconfigurationComplete message. The UE 403 stores the reference configuration on a dedicated variable. At 424, once one of the execution conditions is met for a prepared PSCell, the UE 403 will use the delta configuration of that PSCell along with the provided reference configuration. Hence the UE 403 will obtain the desired full configuration for that PSCell. At 426, the UE 403 sends, to the S-SN 402, RRC Reconfiguration Complete for PSCell-1.

This first option is proposed to avoid breaking the 3GPP paradigm, S-SN 402 may want to use the SRB3 and configure the UE 403 by itself.

For a second option, where MN 401 provides the SAPC to the UE 403, the actions shown in the rectangular box 408 will be performed. In a nutshell, the MN 401 configures the UE 403 directly via the link between the MN 401 and the UE 403.

At 428, the MN 401 transmits, to the UE 403, RRC Reconfiguration (either new message or RRC from MN 401 modification) which may contain SAPC. For example, one reference configuration for all full configurations and Delta configuration per PScell.

At 430, the UE 403 confirms the reception of the provided configurations, e.g., by sending a RRCReconfigurationComplete message. The UE 403 stores the reference configuration on a dedicated variable. At 432, the MN 401 transmits, to the S-SN 402, SN RRC Reconfiguration Complete. At 434, once one of the execution conditions is met for a prepared PSCell, the UE 403 will use the delta configuration of that PSCell along with the provided reference configuration. Hence the UE 403 will obtain the desired full configuration for that PSCell. At 436, the UE 403 transmits, to the MN 401, RRCReconfigurationComplete message, which may contain SN RRC Reconfiguration Complete for delta configuration of PSCell-1. At 438, the MN 401 transmits, to the S-SN 402, SN Reconfiguration Complete related to delta configuration of PSCell-1.

### Third Scenario

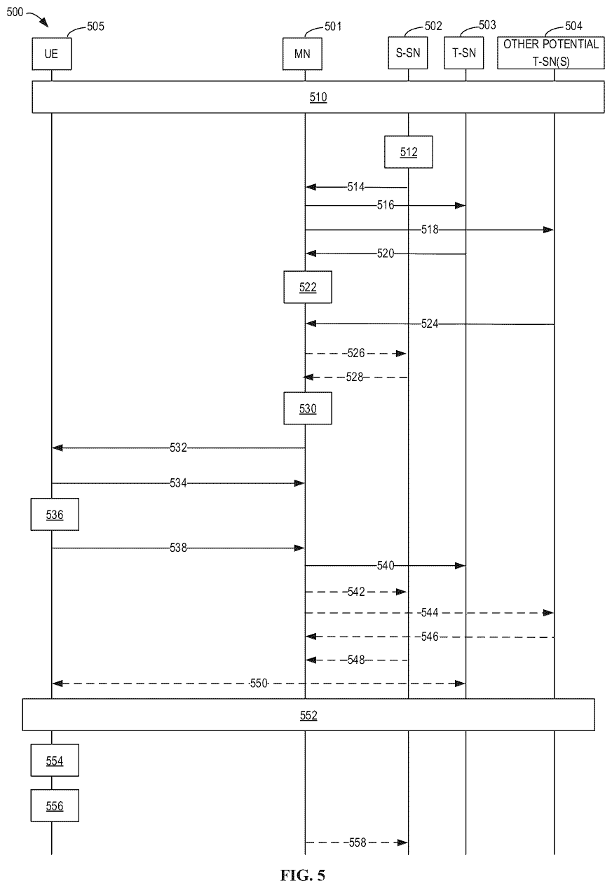

The third scenario relates to a conditional SN change procedure which is SN initiated. FIG. 5 illustrates a signaling chart 500 for reference configuration generation in the third scenario according to some example embodiments of the present disclosure. As described above, the procedure in FIG. 3 refers to a scenario where the preparation of PSCells for SAPC is initiated by MN. The second procedure shown in FIG. 4 refers to a scenario where the preparation of PSCells for SAPC is initiated by SN but the candidate PSCells are also under the same S-SN. The third procedure shown in FIG. 5 is for the case that the candidate PScells for SAPC are under the different SN (target SN(s)) and the procedure is initiated by the S-SN.

In FIG. 5, the UE 505 may be an example implementation of the terminal device 130 in FIG. 1, the MN 501 may be an example implementation of the MN 110 in FIG. 1, and the S-SN 502, T-SN 503 and/or other potential T-SN(s) 304 may be an example implementation of the SN 120 in FIG. 1.

At 510, the UE 505 is in dual connectivity and served by both MN 501 and S-SN 502. At 512, the S-SN 502 determines the preparation of candidate PSCells for SAPC where the candidate PSCells are under different SN (T-SN(s)). At 514, the S-SN 502 sends the SN change required message to request the preparation of candidate PScells. The S-SN 502 excludes the source SN configuration (S-SN SCG configuration) in this message as neither MN 501 nor target SNs require the S-SN's configuration for delta configuration generation. Instead, the MN 501 will determine the reference configuration and delta configurations, hence signaling is saved. Alternatively, full configuration may be sent to be also considered as part of reference configuration generation if the source SN is expected to be part of selective activation.

At 516 and 518, the MN 501 transmits SN Addition Request to the T-SN 503 and the other potential T-SN(s) 504, indicates CPA to CPC for SAPC, and indicates that the MN 501 generates reference configuration. At 520, the T-SN 503 transmits SN Addition Request Acknowledge to the MN 501, and transmits full RRC reconfigurations per PSCell to the MN 501. Alternatively, the SN delegates MN 501 for Reference configuration. At 522, the MN 501 stores full configuration until all configurations are received. At 524, the other potential T-SN(s) 504 transmits SN Addition Request Acknowledge to the MN 501, and transmits full RRC reconfigurations per PSCell to the MN 501. Alternatively, the SN delegates MN 501 for Reference configuration. At 526, the MN 501 transmits an SN Modification Request to the S-SN 502. At 528, the S-SN 502 transmits an SN Modification Request Acknowledgement (ACK) to the MN 501.

At 530, the MN 501 generates one reference configuration for all prepared PSCells that will be used as reference configuration by the UE 505 during SAPC. The MN 501 will also generate the delta configurations such that using each delta configuration along with the reference configuration results in the original full configuration that the target SNs provided for each prepared PSCell. Alternatively, the MN 501 may indicate the reference back to the target SN and the delta configuration may be provided by the target SN. It should be noted that the reference configuration is generated at the MN 501. Compared with the existing solutions where the delta configurations generated by the MN 501 was referring to source SN's or initial serving SN's RRC reconfiguration, in the proposed solutions, the delta configurations are generated for the reference configuration generated by MN 501.

At 532, the MN 501 provides the conditional reconfigurations of prepared PSCells in delta configuration form. The MN 501 also provides one reference configuration for all prepared target PSCells where the UE 505 will use the delta configurations along with the provided reference configuration.

At 534, the UE 505 confirms the reception of the provided configurations, e.g., by sending a RRCReconfigurationComplete message. The UE 505 stores the reference configuration on a dedicated variable.

At 536, once one of the execution conditions is met for a prepared PSCell, the UE 505 will use the delta configuration of that PSCell along with the provided reference configuration. Hence the UE 505 will obtain the desired full configuration for that PSCell where the target SN has provided to the MN 501.

At steps 538 to 352, the UE 505 access to that candidate PSCell that is determined in step 536. More specifically, at 538, the UE 505 transmits, to the MN 501, RRCReconfigurationComplete message containing SN RRCReconfigurationComplete for delta configuration of PSCell-1. At 540, the MN 501 transmits, to the T-SN 503, SN Reconfiguration Complete related to delta configuration of PSCell-1. At 542, the MN 501 transmits, to the S-SN 502, SN Release Request. At 544, the MN 501 transmits, to other potential T-SN(s) 504, SN Release Request. At 546 and 548, the other potential T-SN(s) 504 and the S-SN 502 transmits, to the MN 501, SN Release Request Acknowledge. At 550, the UE 505 and the T-SN 503 performs a random access procedure. At 552, an SAPC adaptation step is performed.

As it is one of the fundamental aspects of the selective activation, at 554, the UE 505 maintains the configurations of full or subset of the prepared PSCells for SAPC. The UE 505 also maintains the reference configuration that is provided by the MN 501 that is needed when the UE 505 applies the maintained delta configurations. Herein, the reference configuration is neither S-SN 502 nor initial SN configuration. It is a configuration that is only meant to be used along with the delta configurations and generated by MN 501.

At 556, as same as the step 536 (but for different PSCell), once the PSCell condition towards one of the prepared PSCells is met, the UE 505 will use the delta configuration of that PSCell along with the provided reference configuration as configured in step 532.

At 558, if SN Modification steps are skipped, the MN 501 transmits SN Change Confirm to the S-SN 502.

### Fourth Scenario

The fourth scenario relates to MN as an anchor point when further SAPC preparation is needed. FIG. 6 illustrates a signaling chart 600 for reference configuration generation according in the fourth scenario to some example embodiments of the present disclosure. The proposed solutions for reference configuration generation at MN are explained for all possible SAPC preparation cases with reference to FIGS. 3-5. In those cases, it is assumed that the network (either MN or SN), prepares the SAPC for the first time, i.e., UE does receive the reference configuration for the first time. In this section, a solution is proposed to provide further SAPC preparations after UE receives the initial SAPC preparations, i.e., after the cases in FIGS. 3-5 happens. FIG. 6 shows the steps of the further SAPC preparations in case MN is an anchor point for reference configuration generation.

In FIG. 6, the UE 605 may be an example implementation of the terminal device 130 in FIG. 1, the MN 601 may be an example implementation of the MN 110 in FIG. 1, and the S-SN 602, T-SN 603 and/or other potential T-SN 604 may be an example implementation of the SN 120 in FIG. 1.

At 610, the UE 605 is in single or dual connectivity with S-SN 602 and the UE 605 is already configured with SAPC, i.e., reference configuration is generated by MN 601 and given to the UE 605 along with the delta configurations of the prepared PSCells. At 612, both UE 605 and MN 601 already knows the reference configuration from previous SAPC configurations.

For a first case, where MN 601 initiates to prepare further SAPC, the actions shown in the rectangular box 650 will be performed. Herein, the MN 601 decides to prepare further candidate PSCells for SAPC (to add more cells to SAPC).

For Case 1A, where MN 601 sends the previous reference configuration during new SAPC preparation, the actions shown in the rectangular box 652 will be performed. The target SNs use this reference configuration and generates the delta configurations for prepared PSCells. At 614, the MN 601 determines to use the existing reference configuration for further SAPC preparations. At 616, 618 and 620, the MN 601 sends the previous reference configuration and indicates the S-SN 602 and/or T-SNs to use this reference configuration to generate delta configurations. For example, the MN 601 transmits SN Addition Request to the S-SN 602, T-SN 603 and other potential T-SN 604, and add MN 601 generated reference configuration and request delta configuration.

At 622, 624 and 626, the S-SN 602, T-SN 603 and other potential T-SN 604 send the delta configurations that are generated with respect to the provided reference configuration that is generated by the MN 601. For example, the S-SN 602, T-SN 603 and other potential T-SN 604 send, to the MN 601, SN Addition Request Ack and delta configurations for provided reference configuration generated by MN 601.

For Case 1B, where MN 601 does not send reference configuration, the actions shown in the rectangular box 654 will be performed. Same as in FIG. 3, the MN 601 sends the SAPC preparation request, and obtains full configurations for those prepared cells. Then, the MN 601 generates the delta configurations with respect to the initial reference configuration. Same as the SAPC procedure when reference configuration is not available, at 628, the MN 601 asks for full configurations and SNs provide full configuration and the MN 601 generates one reference configuration and per PSCell delta configuration. Alternatively, the MN 601 may generate new reference configuration and delta configurations for the received full configurations.

For a second case, where S-SN 602 initiates to prepare further SAPCs, the actions shown in the rectangular box 660 will be performed. Herein, the S-SN 602 decides to prepare further candidate PSCells for SAPC.

For Case 2A, where SN decides to prepare further intra SN SAPC via SRB3 or SRB1 (without MN 601 involvement), the actions shown in the rectangular box 662 will be performed. In this case, the further candidate PSCells are also from the S-SN 602, i.e., intra-SN SAPC. At 630, the S-SN 602 sends the preparation request for the candidate PSCells and it excludes the S-SN's configuration since the MN 601 does not need the S-SN's configuration for reference or delta configuration generation. Thereby, signaling is saved. The S-SN 602 provides the full configurations for the candidate PScells. At 632, the MN 601 uses the previous reference configuration and generates delta configuration for those new candidate PSCells to add them to SAPC. The MN 601 determines to use the existing reference configuration for further SAPC preparations. At 634, the MN 601 sends SN Addition Confirm and the delta configurations that are generated with respect to the previous reference configuration generated by MN 601.

In some alternative example embodiments, the MN 601 generates a new reference and delta configuration and sends them to the S-SN 602. Alternatively, the MN 601 sends the generated delta configurations directly to the UE 605 and indicate that those delta configurations should be used with the previous reference configuration. In some alternative example embodiments, the MN 601 sends the new reference configuration along with the generated delta configurations directly to the UE 605 and indicates that this reference configuration is a new configuration that the UE 605 should use together with the delta configurations that are provided in the same message.

For Case 2B, where SN decides to prepare further intra SN SAPC via SRB3 or SRB1 (without MN 601 involvement), the actions shown in the rectangular box 664 will be performed. In Case 2B, the further candidate PScells are from T-SN(s), i.e., inter-SN PSCell change.

At 636, similar to step 630, the S-SN 602 sends the preparation request for the candidate PSCells and it excludes the S-SN's configuration since the MN 601 does not need the S-SN's configuration for reference or delta configuration generation (hence saves signaling). The difference between step 630 and step 636 is that the S-SN 602 does not send any full configuration for candidate PSCells as it will be generated by the T-SNs.

At 638, the MN 601 uses the previous reference configuration and generates delta configuration for those new candidate PSCells to add them to SAPC. The MN 601 determines to use the existing reference configuration for further SAPC preparations. At 640 and 642, the MN 601 sends the previous reference configuration and indicates the T-SNs to use this reference configuration to generate delta configurations. For example, the MN 601 transmits SN Addition Request to the T-SN 603 and other potential T-SN 604, and add MN 601 generated reference configuration and request delta configuration. At 644 and 646, the T-SN 603 and other potential T-SN 604 send the delta configurations that are generated with respect to the provided reference configuration that is generated by the MN 601. For example, the T-SN 603 and other potential T-SN 604 send, to the MN 601, SN Addition Request Ack and delta configurations for provided reference configuration generated by MN 601.

In some cases, the MN 601 sends the reference configuration to the T-SNs. However, in these cases, it is not specified how the reference configuration will be generated, and which reference configuration will be send to the T-SNs. In this disclosure, the proposed solutions specify the reference configuration as the configuration that MN 601 generates. In latter phase of SAPC (further PSCell preparation), the MN 601 shares that MN 601 generated reference configuration with the T-SNs.

### Reference Configuration Generation

In some example embodiments, the full target cell configuration may comprise information elements defining a set of parameters to one or more second cells, the full target cell configuration information elements representing the second cell-specific configurations. The full target cell configuration information element may comprise at least one of the following:
1) a cellGroupId indicating a cell group,
2) a physCellId identifying the physical cell ID (PCI) of a prepared cell,
3) a newUE-Identity indicating a Radio Network Temporary Identifier (RNTI) to be used to identify the UE in the prepared cell,
4) a rach-ConfigDedicated indicating random access channel (RACH) parameters to be used in the prepared cell, or
5) a p-NR-FR1 indicating power to be used in the prepared cell.

It should be understood that the above examples are described merely for purpose of description. The full target cell configuration information element may comprise any other suitable information element. The scope of the present disclosure is not limited in this respect.

The master node tries to find the common information element provided in each target cell configuration and picks only the common parameters. The common parameters are included in the reference configuration.

In some further example embodiments, the reference configuration may need to be a full configuration in that case, the information elements that are the most common in all target cell configurations obtained by MN is used to make sure that the least amount of changes are required on top of the reference configuration to compile the full target configuration.

In view of the above, the proposed solutions are simple to coordinate the reference configuration between the network nodes. Moreover, the proposed solutions can advantageously minimize the signaling overhead in the air interface, and avoid invalidity issue of the delta configurations during the SAPC.

### Example Methods, Apparatuses and Devices

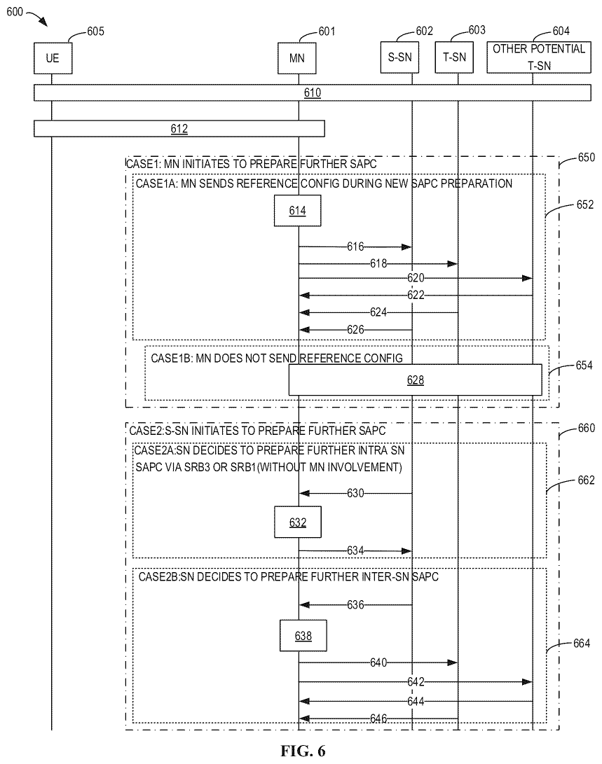

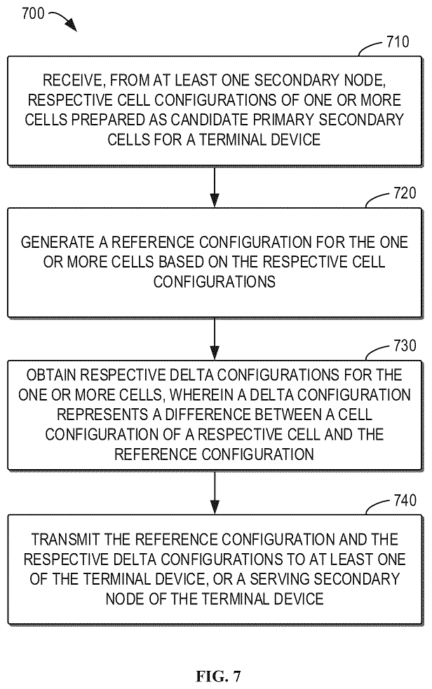

FIG. 7 shows a flowchart of an example method 700 implemented at a master node in accordance with some example embodiments of the present disclosure. For the purpose of discussion, the method 700 will be described from the perspective of the master node 110 in FIG. 1.

At block 710, the master node 110 receives, from at least one secondary node, respective cell configurations of one or more cells prepared as candidate primary secondary cells for a terminal device.

At block 720, the master node 110 generates a reference configuration for the one or more cells based on the respective cell configurations.

At block 730, the master node 110 obtains respective delta configurations for the one or more cells. A delta configuration represents a difference between a cell configuration of a respective cell and the reference configuration.

At block 740, the master node 110 transmits the reference configuration and the respective delta configurations to at least one of the terminal device, or a serving secondary node of the terminal device.

In some example embodiments, the method 700 may further comprise: transmitting, to the at least one secondary node, a first indication that reference configuration generation is to be performed by a master node of the terminal device.

In some example embodiments, the method 700 may further comprise: receiving, from the at least one secondary node, a second indication to authorize the master node with the reference configuration generation.

In some example embodiments, the method 700 may further comprise: transmitting the reference configuration to the at least one secondary node; and receiving the respective delta configurations from the at least one secondary node.

In some example embodiments, the one or more cells are prepared for conditional secondary node addition or conditional secondary node change initiated by a mater node serving the terminal device, and the at least one secondary node acts as a candidate secondary node of the terminal device, and the reference configuration and the respective delta configurations are transmitted to the terminal device.

In some example embodiments, the one or more cells are prepared for an intra-node primary secondary cell change initiated by the serving secondary node.

In some example embodiments, the one or more cells are prepared for conditional secondary node change initiated by the serving secondary node.

In some example embodiments, the method 700 may further comprise: receiving, from the serving secondary node, a request to prepare the candidate primary secondary cells for the terminal device. A secondary cell group configuration of the serving secondary node is excluded from the request.

In some example embodiments, the method 700 may further comprise: obtaining respective further delta configurations for one or more further cells prepared as further candidate secondary cells for the terminal device, wherein a further delta configuration represents a difference between a further cell configuration of a respective further cell and the reference configuration; and transmitting the respective further delta configurations to at least one of the terminal device or the serving secondary node.

In some example embodiments, the method 700 may further comprise: transmitting the reference configuration to a first secondary node providing a first further cell of the one or more further cells; and receiving the further delta configuration of the first further cell from the first secondary node.

In some example embodiments, the method 700 may further comprise: transmitting, to a second secondary node providing a second further cell of the one or more further cells, a request to prepare the further candidate secondary cells for the terminal device; and receiving, from the second secondary node, a further cell configuration of the second further cells; and determining a further delta configuration of the second further cell based on the further cell configuration and the reference configuration.

In some example embodiments, the method 700 may further comprise: obtaining respective further cell configurations of one or more further cells prepared as further candidate primary secondary cells for the terminal device; generating a further reference configuration for the one or more further cells based on the respective further cell configurations; obtaining respective further delta configurations for the one or more further cells, wherein a further delta configuration represents a difference between a further cell configuration of a respective further cell and the further reference configuration; and transmitting the further reference configuration and the respective further delta configurations to at least one of the terminal device, or the serving secondary node.

In some example embodiments, a cell configuration comprises a plurality of information elements, and the method 700 may further comprise: determining one or more information elements common to the respective cell configurations; and incorporating the one or more information elements into the reference configuration.

In some example embodiments, a cell configuration comprises a plurality of information elements, and the method 700 may further comprise: for each information element of the plurality of information elements, determining a value for the information element based on values for the information element in the respective cell configurations; and set the information element in the reference configuration with the determined value.

FIG. 8 shows a flowchart of an example method 800 implemented at a secondary node in accordance with some example embodiments of the present disclosure. For the purpose of discussion, the method 800 will be described from the perspective of the secondary node 120 in FIG. 1.

At block 810, the secondary node 120 determines a cell configuration of a cell prepared as a candidate primary secondary cell for a terminal device.

At block 820, the secondary node 120 transmits the cell configuration to a master node serving the terminal device for generating a reference configuration for one or more cells comprising the cell.

In some example embodiments, the method 800 may further comprise: receiving, from the master node, a first indication that reference configuration generation is to be performed by the master node.

In some example embodiments, the method 800 may further comprise: transmitting, to the network device, a second indication to authorize the master node with the reference configuration generation.

In some example embodiments, the method 800 may further comprise: receiving the reference configuration from the master node; determining a delta configuration based on the cell configuration and the reference signal; and transmitting the delta configuration to the master node.

In some example embodiments, the method 800 may further comprise: receiving, from the mater node, the reference configuration and respective delta configurations for the one or more cells, wherein a delta configuration represents a difference between a cell configuration of a respective cell and the reference configuration; and transmitting the reference configuration and the respective delta configurations to the terminal device.

In some example embodiments, the cell is prepared for conditional secondary node addition or conditional secondary node change initiated by the mater node.

In some example embodiments, the cell is prepared for an intra-node primary secondary cell change initiated by a serving secondary node of the terminal device.

In some example embodiments, the cell is prepared for conditional secondary node change initiated by a serving secondary node of the terminal device.

In some example embodiments, the method 800 may further comprise: receiving the reference configuration from the master node; determining a further cell configuration for a first further cell prepared as a further candidate secondary cell for the terminal device; determining a further delta configuration for the first further cell based on the further cell configuration and the reference configuration; and transmitting the further delta configuration of the first further cell to the master node.

In some example embodiments, the method 800 may further comprise: receiving, from the mater node, a request to prepare a further candidate secondary cell for the terminal device; and transmitting, to the master node, a further cell configuration of a second further cell prepared as the further candidate secondary cell.

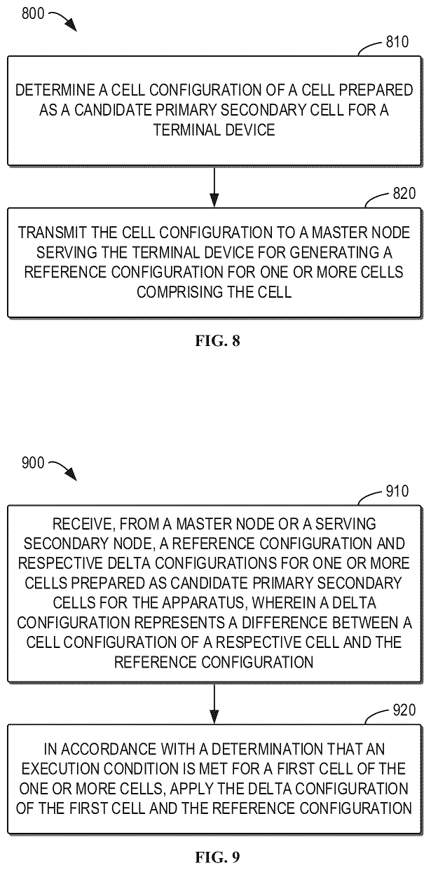

FIG. 9 shows a flowchart of an example method 900 implemented at a terminal device in accordance with some example embodiments of the present disclosure. For the purpose of discussion, the method 900 will be described from the perspective of the terminal device 130 in FIG. 1.

At block 910, the terminal device 130 receives, from a master node or a serving secondary node, a reference configuration and respective delta configurations for one or more cells prepared as candidate primary secondary cells for the apparatus. A delta configuration represents a difference between a cell configuration of a respective cell and the reference configuration.

At block 920, in accordance with a determination that an execution condition is met for a first cell of the one or more cells, the terminal device 130 applies the delta configuration of the first cell and the reference configuration.

In some example embodiments, the method 900 may further comprise: maintaining the reference configuration and at least a subset of the respective delta configurations.

In some example embodiments, the method 900 may further comprise: in accordance with a determination that an execution condition is met for a second cell of the one or more cells, applying the delta configuration of the second cell and the reference configuration.

In some example embodiments, the one or more cells are prepared for conditional secondary node addition or conditional secondary node change initiated by the mater node.

In some example embodiments, the one or more cells are prepared for an intra-node primary secondary cell change initiated by the serving secondary node.

In some example embodiments, the one or more cells are prepared for conditional secondary node change initiated by the serving secondary node.

In some example embodiments, the method 900 may further comprise: receiving, from the master node or the serving secondary node, respective further delta configurations for one or more further cells prepared as further candidate secondary cells for the apparatus. A further delta configuration represents a difference between a further cell configuration of a respective further cell and the reference configuration.

In some example embodiments, the method 900 may further comprise: receiving, from the master node or the serving secondary node, a further reference configuration and respective further delta configurations for one or more further cells prepared as further candidate primary secondary cells for the apparatus. A further delta configuration represents a difference between a further cell configuration of a respective further cell and the further reference configuration.

In some example embodiments, a first apparatus capable of performing any of the method 700 (for example, the master node 110 in FIG. 1) may comprise means for performing the respective operations of the method 700. The means may be implemented in any suitable form. For example, the means may be implemented in a circuitry or software module. The first apparatus may be implemented as or included in the master node 110 in FIG. 1.

In some example embodiments, the first apparatus comprises means for receiving, from at least one secondary node, respective cell configurations of one or more cells prepared as candidate primary secondary cells for a terminal device; means for generating a reference configuration for the one or more cells based on the respective cell configurations; means for obtaining respective delta configurations for the one or more cells, wherein a delta configuration represents a difference between a cell configuration of a respective cell and the reference configuration; and means for transmitting the reference configuration and the respective delta configurations to at least one of the terminal device, or a serving secondary node of the terminal device.

In some example embodiments, the first apparatus may further comprise: means for transmitting, to the at least one secondary node, a first indication that reference configuration generation is to be performed by a master node of the terminal device.

In some example embodiments, the first apparatus may further comprise: means for receiving, from the at least one secondary node, a second indication to authorize the master node with the reference configuration generation.

In some example embodiments, the first apparatus may further comprise: means for transmitting the reference configuration to the at least one secondary node; and means for receiving the respective delta configurations from the at least one secondary node.

In some example embodiments, the one or more cells are prepared for conditional secondary node addition or conditional secondary node change initiated by a mater node serving the terminal device, and the at least one secondary node acts as a candidate secondary node of the terminal device, and the reference configuration and the respective delta configurations are transmitted to the terminal device.

In some example embodiments, the one or more cells are prepared for an intra-node primary secondary cell change initiated by the serving secondary node.

In some example embodiments, the one or more cells are prepared for conditional secondary node change initiated by the serving secondary node.

In some example embodiments, the first apparatus may further comprise: means for receiving, from the serving secondary node, a request to prepare the candidate primary secondary cells for the terminal device. A secondary cell group configuration of the serving secondary node is excluded from the request.

In some example embodiments, the first apparatus may further comprise: means for obtaining respective further delta configurations for one or more further cells prepared as further candidate secondary cells for the terminal device, wherein a further delta configuration represents a difference between a further cell configuration of a respective further cell and the reference configuration; and means for transmitting the respective further delta configurations to at least one of the terminal device or the serving secondary node.

In some example embodiments, the first apparatus may further comprise: means for transmitting the reference configuration to a first secondary node providing a first further cell of the one or more further cells; and means for receiving the further delta configuration of the first further cell from the first secondary node.

In some example embodiments, the first apparatus may further comprise: means for transmitting, to a second secondary node providing a second further cell of the one or more further cells, a request to prepare the further candidate secondary cells for the terminal device; and means for receiving, from the second secondary node, a further cell configuration of the second further cells; and means for determining a further delta configuration of the second further cell based on the further cell configuration and the reference configuration.

In some example embodiments, the first apparatus may further comprise: means for obtaining respective further cell configurations of one or more further cells prepared as further candidate primary secondary cells for the terminal device; means for generating a further reference configuration for the one or more further cells based on the respective further cell configurations; means for obtaining respective further delta configurations for the one or more further cells, wherein a further delta configuration represents a difference between a further cell configuration of a respective further cell and the further reference configuration; and means for transmitting the further reference configuration and the respective further delta configurations to at least one of the terminal device, or the serving secondary node.

In some example embodiments, a cell configuration comprises a plurality of information elements, and the first apparatus may further comprise: means for determining one or more information elements common to the respective cell configurations; and means for incorporating the one or more information elements into the reference configuration.

In some example embodiments, a cell configuration comprises a plurality of information elements, and the first apparatus may further comprise: for each information element of the plurality of information elements, means for determining a value for the information element based on values for the information element in the respective cell configurations; and set the information element in the reference configuration with the determined value.

In some example embodiments, the first apparatus further comprises means for performing other operations in some example embodiments of the method 700 or the master node 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the secondary node 120 in FIG. 1) may comprise means for performing the respective operations of the method 800. The means may be implemented in any suitable form. For example, the means may be implemented in a circuitry or software module. The second apparatus may be implemented as or included in the secondary node 120 in FIG. 1.

In some example embodiments, the second apparatus comprises means for determining a cell configuration of a cell prepared as a candidate primary secondary cell for a terminal device; and means for transmitting the cell configuration to a master node serving the terminal device for generating a reference configuration for one or more cells comprising the cell.

In some example embodiments, the second apparatus may further comprise: means for receiving, from the master node, a first indication that reference configuration generation is to be performed by the master node.

In some example embodiments, the second apparatus may further comprise: means for transmitting, to the network device, a second indication to authorize the master node with the reference configuration generation.

In some example embodiments, the second apparatus may further comprise: means for receiving the reference configuration from the master node; means for determining a delta configuration based on the cell configuration and the reference signal; and means for transmitting the delta configuration to the master node.

In some example embodiments, the second apparatus further comprises: means for receiving, from the mater node, the reference configuration and respective delta configurations for the one or more cells, wherein a delta configuration represents a difference between a cell configuration of a respective cell and the reference configuration; and means for transmitting the reference configuration and the respective delta configurations to the terminal device.

In some example embodiments, the cell is prepared for conditional secondary node addition or conditional secondary node change initiated by the mater node.

In some example embodiments, the cell is prepared for an intra-node primary secondary cell change initiated by a serving secondary node of the terminal device.

In some example embodiments, the cell is prepared for conditional secondary node change initiated by a serving secondary node of the terminal device.

In some example embodiments, the second apparatus may further comprise: means for receiving the reference configuration from the master node; means for determining a further cell configuration for a first further cell prepared as a further candidate secondary cell for the terminal device; means for determining a further delta configuration for the first further cell based on the further cell configuration and the reference configuration; and means for transmitting the further delta configuration of the first further cell to the master node.

In some example embodiments, the second apparatus may further comprise: means for receiving, from the mater node, a request to prepare a further candidate secondary cell for the terminal device; and means for transmitting, to the master node, a further cell configuration of a second further cell prepared as the further candidate secondary cell.

In some example embodiments, the second apparatus further comprises means for performing other operations in some example embodiments of the method 800 or the secondary node 120. In some example embodiments, the means comprises at least one processor; and at least one memory storing instructions that, when executed by the at least one processor, cause the performance of the second apparatus.

In some example embodiments, a third apparatus capable of performing any of the method 900 (for example, the terminal device 130 in FIG. 1) may comprise means for performing the respective operations of the method 900. The means may be implemented in any suitable form. For example, the means may be implemented in a circuitry or software module. The third apparatus may be implemented as or included in the terminal device 130 in FIG. 1.

In some example embodiments, the third apparatus comprises means for receiving, from a master node or a serving secondary node, a reference configuration and respective delta configurations for one or more cells prepared as candidate primary secondary cells for the apparatus, wherein a delta configuration represents a difference between a cell configuration of a respective cell and the reference configuration; and means for in accordance with a determination that an execution condition is met for a first cell of the one or more cells, applying the delta configuration of the first cell and the reference configuration.

In some example embodiments, the third apparatus may further comprise: means for maintaining the reference configuration and at least a subset of the respective delta configurations.

In some example embodiments, the third apparatus may further comprise: means for in accordance with a determination that an execution condition is met for a second cell of the one or more cells, applying the delta configuration of the second cell and the reference configuration.

In some example embodiments, the one or more cells are prepared for conditional secondary node addition or conditional secondary node change initiated by the mater node.

In some example embodiments, the one or more cells are prepared for an intra-node primary secondary cell change initiated by the serving secondary node.

In some example embodiments, the one or more cells are prepared for conditional secondary node change initiated by the serving secondary node.

In some example embodiments, the third apparatus may further comprise: means for receiving, from the master node or the serving secondary node, respective further delta configurations for one or more further cells prepared as further candidate secondary cells for the apparatus. A further delta configuration represents a difference between a further cell configuration of a respective further cell and the reference configuration.

In some example embodiments, the third apparatus may further comprise: means for receiving, from the master node or the serving secondary node, a further reference configuration and respective further delta configurations for one or more further cells prepared as further candidate primary secondary cells for the apparatus. A further delta configuration represents a difference between a further cell configuration of a respective further cell and the further reference configuration.

In some example embodiments, the third apparatus further comprises means for performing other operations in some example embodiments of the method 900 or the terminal device 130. In some example embodiments, the means comprises at least one processor; and at least one memory storing instructions that, when executed by the at least one processor, cause the performance of the third apparatus.

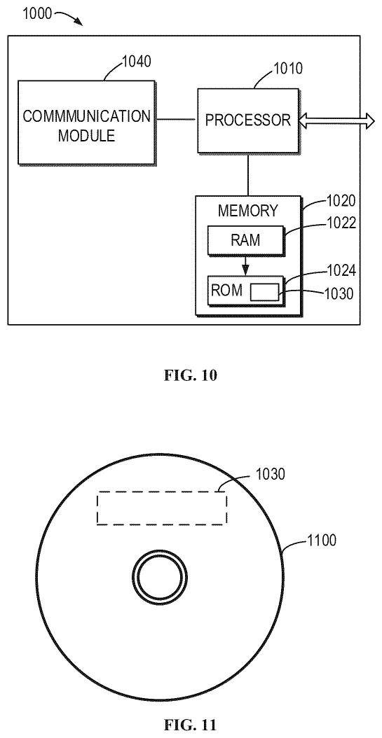

FIG. 10 is a simplified block diagram of a device 1000 that is suitable for implementing example embodiments of the present disclosure. The device 1000 may be provided to implement a communication device, for example, the master node 110, the secondary node 120 or the terminal device 130 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus to:
determine a cell configuration of a cell prepared as a candidate primary secondary cell for a terminal device; and
transmit the cell configuration to a master node serving the terminal device for generating a reference configuration for one or more cells comprising the cell.

2. The apparatus of claim 1, wherein the instructions, when executed by the at least one processor, cause the apparatus to:
receive, from the master node, a first indication that reference configuration generation is to be performed by the master node.

3. The apparatus of claim 2, wherein the instructions, when executed by the at least one processor, cause the apparatus to:
transmit, to the network device, a second indication to authorize the master node with the reference configuration generation.

4. The apparatus of claim 1, wherein the instructions, when executed by the at least one processor, cause the apparatus to:
receive the reference configuration from the master node;
determine a delta configuration based on the cell configuration and the reference signal; and
transmit the delta configuration to the master node.

5. The apparatus of claim 1, wherein the apparatus is implemented at a serving secondary node of the terminal device, and the instructions, when executed by the at least one processor, cause the apparatus to:
receive, from the mater node, the reference configuration and respective delta configurations for the one or more cells, wherein a delta configuration represents a difference between a cell configuration of a respective cell and the reference configuration; and
transmit the reference configuration and the respective delta configurations to the terminal device.

6. The apparatus of claim 1, wherein the cell is prepared for conditional secondary node addition or conditional secondary node change initiated by the mater node.

7. The apparatus of claim 1, wherein the cell is prepared for an intra-node primary secondary cell change initiated by a serving secondary node of the terminal device.

8. A method comprising:
determining, at a secondary node, a cell configuration of a cell prepared as a candidate primary secondary cell for a terminal device; and
transmitting the cell configuration to a master node serving the terminal device for generating a reference configuration for one or more cells comprising the cell.

9. The method of claim 8, further comprising:
receiving, from the master node, a first indication that reference configuration generation is to be performed by the master node.

10. The method of claim 9, further comprising:
transmitting, to the network device, a second indication to authorize the master node with the reference configuration generation.

11. The method of claim 8, further comprising:
receiving the reference configuration from the master node;
determining a delta configuration based on the cell configuration and the reference signal; and
transmitting the delta configuration to the master node.

12. The method of claim 8, further comprising:
receiving, from the mater node, the reference configuration and respective delta configurations for the one or more cells, wherein a delta configuration represents a difference between a cell configuration of a respective cell and the reference configuration; and
transmitting the reference configuration and the respective delta configurations to the terminal device.

13. The method of claim 8, wherein the cell is prepared for conditional secondary node addition or conditional secondary node change initiated by the mater node.

14. The method of claim 8, wherein the cell is prepared for an intra-node primary secondary cell change initiated by a serving secondary node of the terminal device.

15. A non-transitory computer readable medium comprising instructions stored thereon for causing an apparatus at least to perform:
determining, at a secondary node, a cell configuration of a cell prepared as a candidate primary secondary cell for a terminal device; and
transmitting the cell configuration to a master node serving the terminal device for generating a reference configuration for one or more cells comprising the cell.

16. The non-transitory computer readable medium of claim 15, further comprising instructions for causing the apparatus at least to perform:
receiving, from the master node, a first indication that reference configuration generation is to be performed by the master node.

17. The non-transitory computer readable medium of claim 16, further comprising instructions for causing the apparatus at least to perform:
transmitting, to the network device, a second indication to authorize the master node with the reference configuration generation.

18. The non-transitory computer readable medium of claim 15, further comprising instructions for causing the apparatus at least to perform:
receiving the reference configuration from the master node;
determining a delta configuration based on the cell configuration and the reference signal; and
transmitting the delta configuration to the master node.

19. The non-transitory computer readable medium of claim 15, further comprising instructions for causing the apparatus at least to perform:
receiving, from the mater node, the reference configuration and respective delta configurations for the one or more cells, wherein a delta configuration represents a difference between a cell configuration of a respective cell and the reference configuration; and
transmitting the reference configuration and the respective delta configurations to the terminal device.

20. The non-transitory computer readable medium of claim 15, wherein the cell is prepared for conditional secondary node addition or conditional secondary node change initiated by the mater node.
